(19) United States
(12) Patent Application Publication
(10) Pub. No.: US 2024/0350234 A1
(43) Pub. Date: Oct. 24, 2024

(54) ZYGOMATIC IMPLANT AND CORRESPONDING SURGICAL METHOD

(71) Applicants: Jean-Luc BEZIAT, CHASSIEU (FR); Bernard CHAPOTAT, VIENNE (FR); Eric SCHNECK, LYON (FR); GLOBAL D, BRIGNAIS (FR)

(72) Inventors: Jean-Luc BEZIAT, CHASSIEU (FR); Bernard CHAPOTAT, VIENNE (FR); Eric SCHNECK, Lyon (FR); Chistophe MARRONE, NOVALAISE (FR); Mathieu BRIAT, VINAY (FR)

(21) Appl. No.: 18/683,364

(22) PCT Filed: Aug. 29, 2022
(86) PCT No.: PCT/EP2022/073968

§ 371 Date: Feb. 13, 2024

(30) Foreign Application Priority Data
Aug. 31, 2021 (FR) 2109093

(51) Int. Cl. A61C 8/00

(52) U.S. Cl. CPC A61C 8/0031; A61C 8/0077

(57) ABSTRACT

Zygomatic implant intended to support a dental prosthesis and to be fixed solely to the jugal face of the zygomatic bone of a patient, this implant comprising: • A zygomatic fixation part (10) arranged to be fixed on the jugal face of the zygomatic bone of a patient, forming a plate which has a fixation opening (100, 101, 102) which passes through the plate and is able to receive a fixation element for fixing the plate on the jugal face of the zygomatic bone of a patient, • A maxillary part (11) comprising at least one elongate element which is arranged to extend opposite the jugal face of the maxillary bone of the patient and of which one end is connected to the zygomatic part and the other end is free and intended to be connected to a connection interface with a dental prosthesis.

The invention relates to the technical field of dental implantology and more particularly to that of zygomatic dental implants, these implants being intended to support a dental prosthesis.

These implants are used in patients presenting with severe bone loss in the upper jaw, whether this is the result of total and long-standing edentation of the jaws, accompanied by disappearance of the alveolar bone which supports the teeth, or of a malformation, trauma or a tumor excision.

Indeed, the loss of the maxillary teeth, in a young patient, leads to progressive resorption of the alveolar bone, which disappears almost entirely. Thus, the height of the maxillary bones decreases and the maxillary sinuses, which they limit, are no longer separated from the oral cavity by alveolar bone but by a thin layer of cortical bone, which is fragile and poorly vascularized.

When the alveolar bone has resorbed, it is no longer possible to place, in this thin bone wall, traditional maxillary dental implants on which a prosthesis would be fixed. Indeed, the bone present would not ensure their fixation and, in any case, these implants would penetrate into the overlying maxillary sinus and would cause infections.

It should also be noted that total alveolar reconstruction using voluminous bone grafts (cranial or iliac) is complex and, what is more, its result is uncertain. It is therefore reserved for rare patients treated by highly experienced craniofacial surgery teams.

However, the use of a complete resin appliance also becomes difficult, if not impossible, due to lack of retention.

An example of a maxillary implant is proposed by the company Spider, under the name MiniZygo.

This implant comprises two parts, a relatively short conventional implant and an osteosynthesis plate fixed by osteosynthesis screws to the maxillary bone in the vicinity of or at its curved part beneath the zygomatic bone. These parts are always at a distance from the zygomaticomaxillary suture and, therefore, from the zygomatic bone.

The implant fixation always requires a substantial amount of residual maxillary bone at the region of its anchorage.

In addition, the plate fixation screws penetrate the maxillary sinus, with the risk of permanent chronic sinusitis.

It is for this reason that implants have been designed to be placed in a solid bone, distant from the residual maxillary bone.

Now, the bones closest to the jaws are the right and left zygomatic bones, located on either side of the jaws and constituting, on each side, the relief of the cheekbone. Such implants, reaching from the lower margin of a maxillary bone to a zygomatic bone, are called zygomatic implants.

These are cylindrical and straight implants which correspond to a simple extrapolation of the conventional implants usually placed in an alveolar position.

A well-known zygomatic implant consists of a straight cylindrical rod having two parts of different diameters, both threaded.

It is positioned from the resorbed alveolar region (or often from the lateral palatine region) to the body of the zygomatic bone, along a rectilinear trajectory. A cavity is thus drilled through the maxillary bone, the drilling being continued in order as to drill a cavity in the zygomatic bone. This trajectory thus passes totally or partially through the maxillary sinus or opens it at least at some point.

One end of the implant is intended to be screwed into one of the two zygomatic bones at the level of its two cortical regions (internal or external), while the other end is intended to be positioned in the palatal region of the maxillary bone.

An implant of this type is sold in particular by the company Straumann or by the company Nobel under the name Branemark System Zygoma.

It is anchored in both the zygomatic bone and the jawbone and is therefore much longer than a traditional implant positioned only in the jawbone. Its length is typically between 35 and 57 mm.

With this technique, patients avoid bone grafts and sinus elevation procedures.

These implants have been widely used for over 10 years, and studies have made it possible to evaluate their effectiveness but also their possible complications.

In fact, these implants are long, and they are moreover inserted in risk zones, because they are close to the orbit and the maxillary sinus.

Thus, the major accident during surgery involves perforation of the floor of the orbit during the drilling of the cavity intended for the implant or subsequently, by the upper part of the implant, during its insertion.

This creates an intra-orbital hematoma that causes compression of the optic nerve, which can lead to blindness.

In addition, the most common postoperative complication is sinusitis.

Indeed, even through there are anatomical differences between patients, the implant necessarily passes at least partially through the sinus. The sinus may present an inflammatory reaction associated with the insertion therein of the implant, as a foreign body.

In addition, a communication between the sinus and the oral cavity may then appear.

This leads to permanent chronic sinusitis, which is a source of great discomfort for patients and will need to be treated with antibiotics.

It should be noted that this sinusitis is very difficult to cure, even after removal of the implant.

It may also be noted that the implant frequently has, at the level of the maxillary bone, an emergence on the palatal side, which hinders the production of the maxillary prosthesis, the transverse diameter of which must be enlarged so as not to be too small with respect to that of the mandibular antagonist arch, whether natural or prosthetic. Sometimes the implant emerges even at the middle of the palate, which is very troublesome for the patient.

Other implants have been proposed in an attempt to overcome these drawbacks.

Mention may be made in particular of the implant described in the patent U.S. Pat. No. 9,125,708.

This implant is still in the form of a straight rod, but it comprises a single threaded part extending from its end intended to be inserted into the zygomatic bone.

The rest of the implant is therefore without a thread.

The implant is put in place in the following way.

A recess or groove is hollowed out on the jugal face of the maxillary bone. A fixation hole is then made at a distance from this recess within the thickness of the body of the zygomatic bone. The implant is then fixed by its threaded end in this fixation hole, while the non-threaded part extends into the recess present on the jugal face of the maxillary bone.

Throughout the description, the term “jugal face” is understood to mean the face of the bone (maxillary or zygomatic) which is in contact with the cheek, that is to say the external face of the bone, directed toward the outside of the patient's face.

Thus, this implant has only one anchoring point at the zygomatic bone, and it is designed not to extend into the cavity of the maxillary sinus.

However, the inventors have observed that there is always a risk of opening the sinus, in particular at the zygomaticomaxillary suture.

Indeed, the implant penetrates into the thickness of the body of the zygomatic bone at the region of this suture, that is to say through the maxillary process of the zygomatic bone. Contrary to what implantology diagrams indicate, the inventors have found that the sinus very often extends into the zygomatic process of the maxillary bone. The risk of opening the sinus is therefore not ruled out. An opening, even of a small size, will be the cause of a sinus infection.

Moreover, the creation of the recess in the jugal face of the maxillary bone very often leads to its perforation, because this bone is very thin, even if the recess is designed not to extend into the cavity of the maxillary sinus.

Thus, the risks of infectious sinus complications are not ruled out with implants of the type described in the patent U.S. Pat. No. 9,125,708. These complications are extremely difficult to treat, and their healing most often entails the removal of all the implant material.

Insofar as the zygomatic bone is curved whilst the implant is straight, there is also a risk of the end of the implant passing through the bone and thus penetrating into the temporal region, which leads to other harmful consequences for the patient.

Finally, it should also be noted that, in order to ensure good stability of the prosthesis, it is necessary to provide on each side not only an implant of the type described in the patent U.S. Pat. No. 9,125,708, but also a traditional implant positioned toward the front of the jaw. This constraint limits the use of this implant, since it is very often impossible to provide these traditional implants because of the loss of bone.

Thus, the known zygomatic implants do indeed permit prosthetic rehabilitation. However, in about 20% of cases, infectious complications appear, and therefore they do not provide a lasting rehabilitation.

Disassembly of all the known zygomatic implants is difficult, although it may prove necessary, particularly in the case of chronic sinusitis sustained by implant infection or in the event of a fracture of the implant.

In fact, when one end of the implant has indeed become osseointegrated in the zygomatic bone, it is then necessary to resect the surrounding bone in order to be able to mobilize the implant and remove it. This leads to significant bone damage, which compromises the integrity of the patient.

It should also be noted that, with the known implants, the intrazygomatic distal end of the implant may fracture accidentally when an excessive force is exerted on the implant while screwing it in. It is then necessary to remove the implant fragment that has remained in the bone, which again requires it to be released by drilling into the bone that surrounds it, with the same harmful consequences for the patient.

The object of the invention is therefore to propose a zygomatic dental implant which avoids these drawbacks.

The approach taken by the inventors runs counter to all the solutions proposed in the prior art by proposing a dental implant which is intended to be fixed only by and on the jugal face of one of the two zygomatic bones, without penetrating into this bone, thereby avoiding any risk of intra-sinus penetration of the implant or of a sinus breach and therefore sinusitis, and allowing easy disassembly of the implant in the event of problems. In other words, this implant is positioned on the jugal face of one of the two zygomatic bones (and not of both of them) and it is fixed by this jugal face by fixation means which themselves can penetrate into this bone. It is preferable that these fixation means do not pass through the zygomatic bone.

Thus, the invention relates to a zygomatic implant for supporting a dental prosthesis and for being fixed only to the jugal face of a zygomatic bone of a patient, this implant comprising:
A zygomatic fixation part arranged to be fixed to the jugal face of the zygomatic bone of a patient, forming a plate, in which there is defined at least one fixation opening which extends through the plate and which is configured to receive a fixation element so as to fix the plate to the jugal face of the zygomatic bone of a patient,
A maxillary part comprising at least one elongate element arranged to extend facing the jugal face of the maxillary bone of the patient, and one end of which is connected to the zygomatic part, and the other end of which is free and is intended to be connected to a connection interface with a dental prosthesis.

In advantageous embodiments, use is moreover made of one or more of the following provisions:
the zygomatic part is formed integrally with the maxillary part.
the implant is made in at least two independent parts, wherein the zygomatic part defines at least one fixation means for an elongate element.
said plate comprises a single fixation opening and, optionally, in this case, on its convex internal face intended to be in contact with the jugal face of the zygomatic bone, at least one relief projecting with respect to said internal face.
said plate comprises at least two fixation openings.
the maxillary part comprises at least two elongate elements, said elongate elements forming an acute angle between them.
said zygomatic part is pre-operatively pre-formed in order to match the external shape of the zygomatic bone of the patient.
said at least one elongate element is pre-operatively pre-formed in order to match the shape and dimensions of the jugal face of the maxillary bone of the patient.

The invention also relates to a kit for producing a zygomatic implant, intended to receive a dental prosthesis and to be fixed only to the jugal face of the zygomatic bone of a patient, comprising:
A zygomatic fixation part arranged to be fixed to the jugal face of the zygomatic bone of a patient, forming a plate, in which there is defined at least one fixation opening which extends through the plate and which is configured to receive a fixation element so as to fix the plate to the jugal face of the zygomatic bone of a patient, the zygomatic part defining at least one fixation means for an elongate element, wherein said elongate element can be removably fixed, and
At least one elongate element arranged to extend facing the jugal face of the maxillary bone of the patient, and one end of which is intended to be fixed in a fixation means of the zygomatic part, and the other end of which is free and is intended to be connected to a connection interface with a dental prosthesis.

In advantageous embodiments, use is moreover made of one or more of the following provisions:
said zygomatic part is pre-operatively pre-formed in order to match the external shape of the zygomatic bone of the patient.
said zygomatic part is standard.
said at least one elongate element is pre-operatively pre-formed in order to match the shape and dimensions of the jugal face of the maxillary bone of the patient.
said at least one elongate element is standard.

The invention lastly relates to a surgical method for the placement of an implant, comprising the following steps:
Incision of the upper vestibular mucosa, at the alveolar region devoid of residual teeth
Subperiosteal detachment exposing the jugal face of the maxillary bones and the jugal face of the zygomatic bone
Drilling into the zygomatic bone, from its jugal face, holes for fixing the fixation elements of the implant
Placement of the zygomatic part of the implant on the jugal face of the zygomatic bone and its fixation in the latter by means of fixation screws
Closure of the access route.

The maxillary part of the implant can be put in place during the initial operation (corresponding to the placement of the zygomatic part) or subsequently, during a second operation.

The invention will be better understood and other objects, advantages and features thereof will become more clearly apparent on reading the following description, which is given with reference to the appended drawings in which:

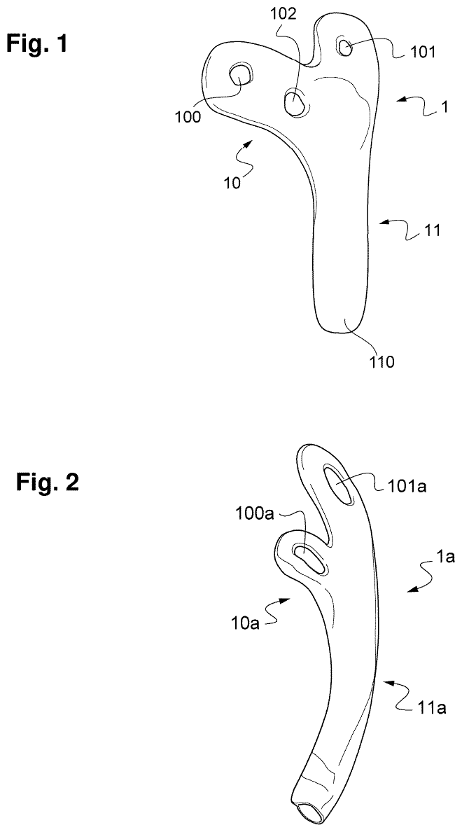

FIG. 1 is a plan view of an example of a zygomatic implant according to the invention.

FIG. 2 is a perspective view of a variant of the implant from FIG. 1.

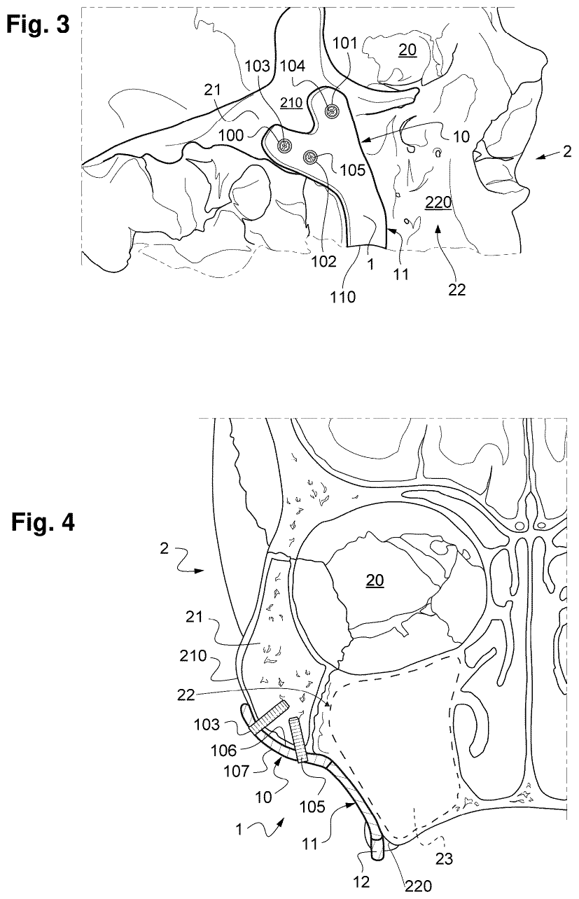

FIG. 3 is an anterior three-quarter perspective view illustrating the implant from FIG. 1 in position on a facial skeleton.

FIG. 4 is a partial view in front section illustrating the implant from FIG. 1 in position on a facial skeleton.

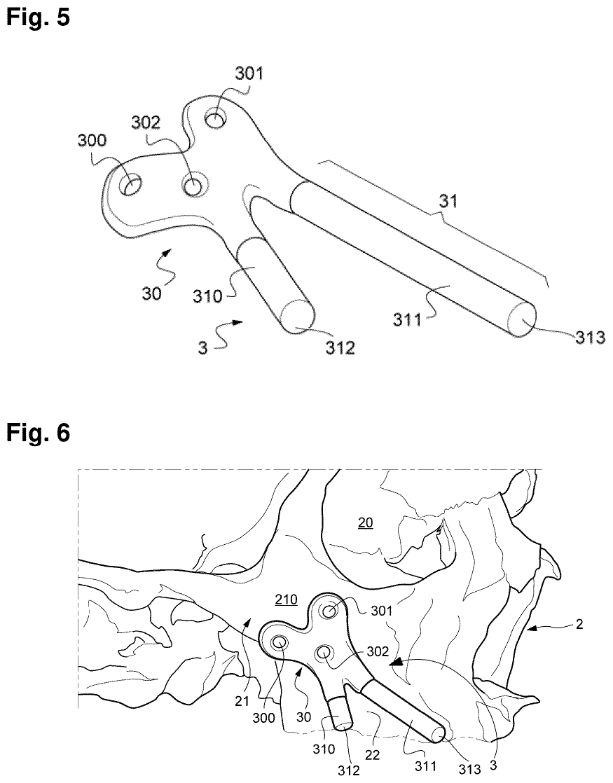

FIG. 5 is a plan view of another example of a zygomatic implant according to the invention.

FIG. 6 is an anterior three-quarter view illustrating the implant of the type from FIG. 5 in position on the right-hand side of a facial skeleton.

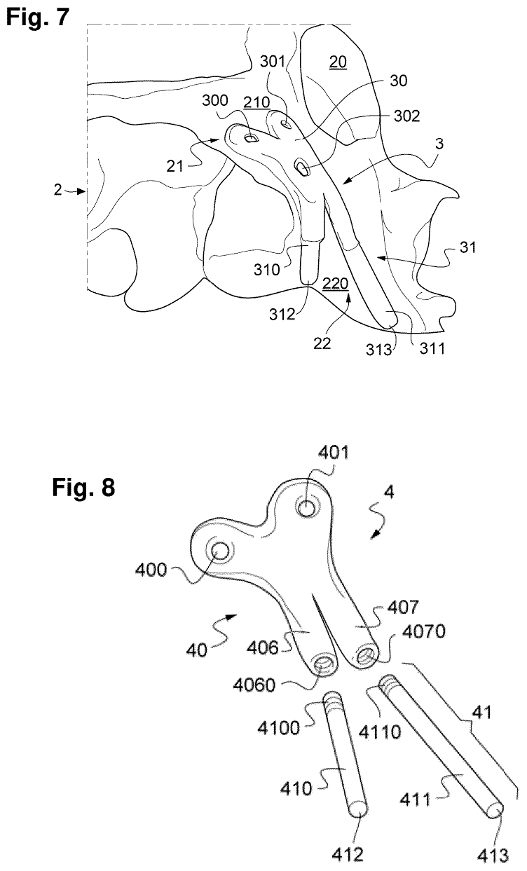

FIG. 7 is a profile view in perspective illustrating the implant of the type from FIG. 5 in position on the right-hand side of a facial skeleton.

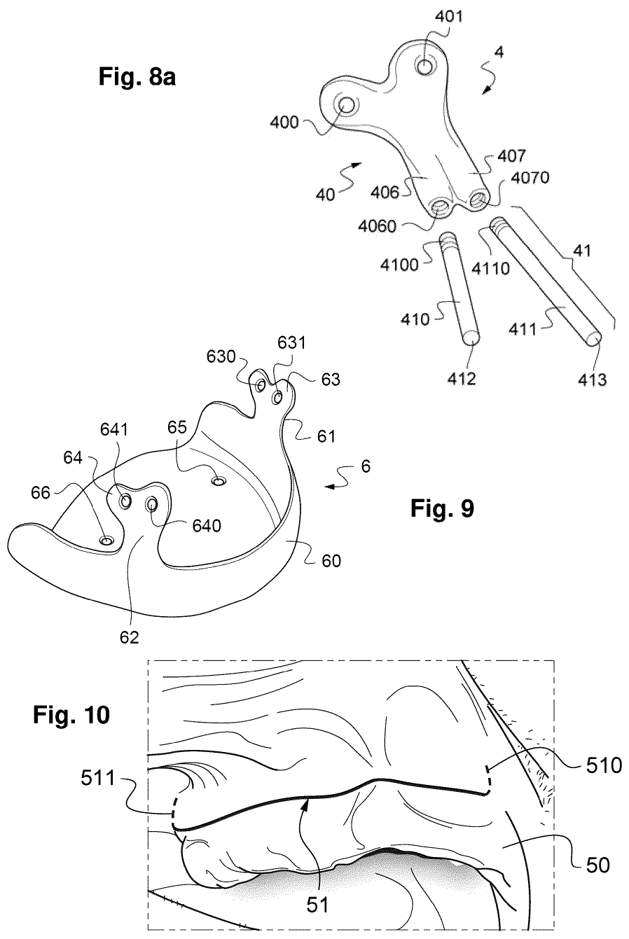

FIG. 8 is a plan view of another example of a zygomatic implant according to the invention made in three independent parts.

FIG. 8a illustrates a variant of FIG. 8.

FIG. 9 is a perspective view of the drilling guide.

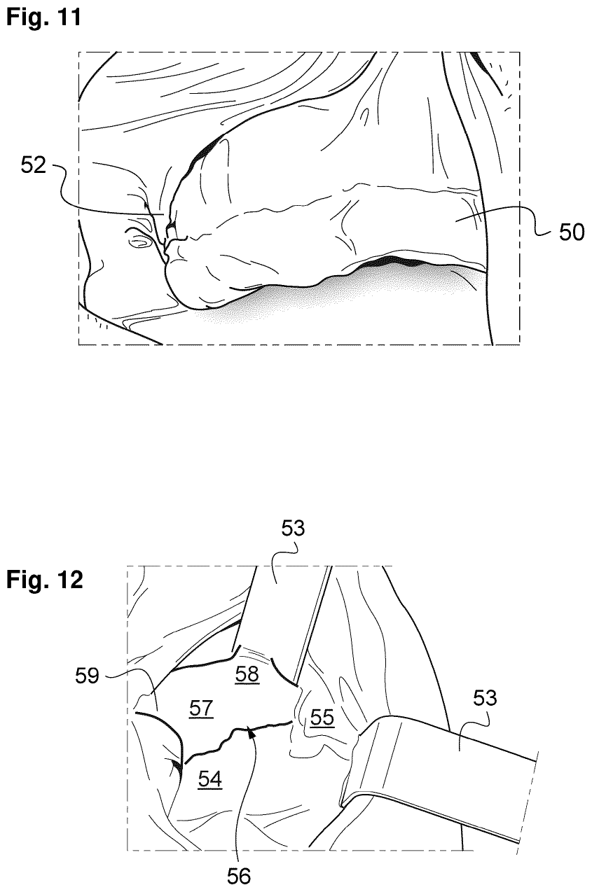

FIG. 10, FIG. 11 and FIG. 12 illustrate three steps of the surgical method for placement of an implant according to the invention.

The elements common to the various figures will be designated by the same references.

FIGS. 1 to 4 illustrate an example of an implant intended to be placed on the right-hand side of the facial skeleton of a patient.

It will be recalled here that the skeleton of the head comprises the skull and the facial skeleton.

They show that this implant 1, made in one piece, comprises a zygomatic part 10 and a maxillary part 11.

The zygomatic part 10 has the shape of a plate. In this example, seen from above, the plate has a general Y-shape, but the invention is not limited to this example. The plate may have any shape, for example the shape of a disk, a triangle, a square, or an X, Z or W shape.

Three fixation openings 100, 101 and 102 are defined in this plate. Each of them extends through the plate and is configured to receive a fixation element, such as an implant screw, for fixing the plate by and on the jugal face of the zygomatic bone of a patient.

However, the invention is not limited to this example. Thus, the plate may have only one fixation opening for a fixation element. In this case, to ensure the stability of the implant, another anchoring means can be provided, for example in the form of a relief. This may in particular be a lug provided on the zygomatic part of the implant, on the surface of this zygomatic part intended to be opposite the jugal face of the zygomatic bone when the implant is put in place on a patient (that is to say the internal face of the zygomatic part), and projecting with respect to this internal face. This lug is intended to be inserted into a corresponding hole made by the surgeon in the jugal face of the zygomatic bone of the patient. It is also possible to provide a right-angled extension of the zygomatic plate, situated at one end of the plate and also projecting with respect to the internal face of the plate. This extension is intended to be inserted under the antero-inferior margin of the zygomatic bone.

The plate can also comprise two fixation openings for a fixation element.

In general, it is preferable for the plate to comprise at least two anchoring means making it possible to ensure stable positioning with respect to the zygomatic bone.

Moreover, this plate is preferably curved so as to adapt to the domed shape of the zygomatic bone.

The maxillary part 11 continues the zygomatic part 10 and forms an elongate element which will extend from the zygomatic part, and facing the maxillary bone, to the dental prosthesis, when the implant is positioned on the facial skeleton. The term “elongate element” is understood to mean an element stretching in length or even longer than wide, the latter extending in this case from the zygomatic part of the implant to the interface for connection with the dental prosthesis.

The length of this maxillary part corresponds substantially to the residual height of the maxillary bone located below the zygomatic bone.

The free end 110 of the maxillary part is intended to be connected to an interface for connection with a dental prosthesis (not illustrated).

This elongate element is not designed to be fixed to the maxillary bone, which is why it has no opening passing through it for receiving a fixation element such as a screw.

As is illustrated in FIG. 5, the invention is not limited to this type of maxillary part, and the latter may comprise several elongate elements.

The shape of the implant 1 is illustrated more precisely in FIG. 2, which illustrates in perspective an implant 1a that is a variant of the implant 1 illustrated in FIG. 1.

Indeed, this implant 1a still comprises a zygomatic part 10a and a maxillary part 11a, but only two fixation openings 100a and 101a for a fixation element are provided in the zygomatic part 10a. Here again, the elongate element 11a has no through-opening for a fixation element.

FIG. 2 shows that the zygomatic part 10a is curved, while the maxillary part 11a is substantially straight.

Reference is now made to FIGS. 3 and 4, which show the implant 1 fixed on a facial skeleton 2.

FIGS. 3 and 4 indicate the osseous orbit 20, the zygomatic bone 21, the maxillary bone 22 and the maxillary sinus 23, the latter being shown by dotted lines (on the right-hand side of the skull). These figures show that the zygomatic part 10 is fixed to the jugal face 210 of the zygomatic bone by means of fixation elements 103, 104 and 105, each of them passing through a fixation opening 100, 101, 102 and being inserted into the thickness of the zygomatic bone 21 while being positioned substantially orthogonally to the jugal face 210 of the bone. These fixation elements may in particular be implant screws made of an osseointegratable material such as titanium or zirconia.

As is shown more precisely in FIG. 4, the concave face 106 of the plate 10 (internal face of the plate) lies opposite the jugal face 210 of the zygomatic bone, so as to come into contact with the latter and match its generally domed shape, while its convex face 107 (external face of the plate) is free. In practice, it will be in contact with the soft tissues of the cheek.

The maxillary part 11 of the implant extends facing the jugal face of the maxillary bone 22. In other words, the maxillary part 11 is not fixed in the maxillary bone.

It is continued, at the side opposite the zygomatic part 10, by an interface 12 for connection with a prosthesis.

Thus, no part of the implant 1 passes through the maxillary bone 22 (except possibly at a notch made in the bony crest of the maxillary bone) or the cavity of the maxillary sinus 23. Moreover, the fixation elements 103, 104, 105 penetrate only into the zygomatic bone, specifically from its jugal face, and are therefore completely distanced from the sinus.

FIG. 5 illustrates another example of an implant 3 according to the invention, intended to be fixed on the right-hand side of the facial skeleton.

This implant 3 still comprises a zygomatic part 30 having the shape of a plate which is preferably curved so that its concave internal face intended to come into contact with the zygomatic bone matches the shape of the latter. Three fixation openings 300, 301, 302 pass through the part 30.

Its maxillary part 31 continues the zygomatic part 30 but comprises two elongate elements 310, 311 extending from the zygomatic part, and not a single elongate element as with the implant from FIG. 1.

FIG. 5 shows that these two elongate elements form an acute angle between them. This angle is generally between 15° and 45°.

FIGS. 6 and 7 illustrate the implant 3 fixed to the facial skeleton 2, on the right-hand side.

In the same way as for the implant 1, the zygomatic part 30 is fixed to the jugal face of the zygomatic bone 21 by means of fixation elements (not illustrated), each of them passing through a fixation opening 300, 301, 302 and being inserted into the thickness of the zygomatic bone while being positioned substantially orthogonally to the jugal face 210 of the bone.

The maxillary part 31 extends facing the jugal face 220 of the maxillary bone. In other words, the maxillary part 11 is not fixed in the maxillary bone.

FIG. 6 shows that, by virtue of the angle between the two elongate elements, the rear element 310 can be directed toward the position of the first molar which has been lost, while the front element 311 extends toward the position of the canine, also extracted.

In practice, the rear element 310 extends substantially vertically.

Thus, the length of each elongate element corresponds substantially to the distance between the lower part of the zygomatic bone of the patient and the zone of the lower part of the maxillary bone (i.e. the alveolar bone or the bony crest) toward which the elongate element is directed.

The free end 312, 313 of each elongate element is intended to be connected to an interface for connection with a dental prosthesis.

By providing an implant 3 having two elongate elements on each side of the facial skeleton, it is possible to stabilize a prosthesis by virtue of these two fixation points, one posterior, one anterior, on each side, without other means being necessary.

FIG. 7 shows the curvature of the zygomatic part of the implant 3, which enables it to adapt to the domed shape of the zygomatic bone.

An implant according to the invention could comprise more than two elongate elements, in particular in cancerology, after excision of an extensive part of the maxillary bones.

A third elongate element may then be envisioned, directed toward the resected palatal region, so as to be able to stabilize an extended maxillary prosthetic reconstruction.

In the embodiments that have been described, the implants are designed in one piece. However, the invention is not limited to these examples, and the implant can be designed in such a way that its zygomatic part and its maxillary part are independent of each other.

Reference is now made to FIG. 8, which illustrates an example of a kit for producing an implant of the type illustrated in FIGS. 5 to 7, that is to say comprising two elongate elements. This implant is made in several parts and it is therefore illustrated here in the disassembled state.

This implant 4 thus comprises a zygomatic part 40 forming a preferably curved plate in which there are defined two fixation openings 400, 401 which extend through the plate and which are intended to receive fixation elements.

This part 40 comprises two fixation means 406, 407 for two elongate elements 410, 411 which form the maxillary part 41 of the implant 4.

In the example illustrated in FIG. 8, the two fixation means form two branches, separated from each other. However, the invention is not limited to this embodiment. As is illustrated in FIG. 8a, these two means can also be joined together over all or part of their length.

These fixation means are intended to receive one end of an elongate element and to rigidly connect it to the zygomatic part 40, so as to effect the assembly between the elongate elements 410, 411 and the zygomatic part 40. The elongate elements can be fixed removably in the fixation means.

The fixation means 406, 407 can thus have, in a non-limiting manner, a substantially cylindrical threaded recess 4060, 4070, while one end of each elongate element 410, 411 comprises a thread 4100, 4110 so as to be able to be screwed into this recess.

The other end 412, 413 of each elongate element 410, 411 is intended to be connected to a prosthesis.

The end of the elongate element can also comprise a ball joint (not shown). The corresponding fixation means then has a complementary recess in which the ball joint is inserted. This embodiment provides a degree of freedom between the zygomatic part and the maxillary part. This allows the surgeon to adjust, during the operation, the position of each elongate element 410, 411 with respect to the zygomatic part 40, in order to find a position that is optimized for the patient.

In practice, this kit can comprise one zygomatic plate and a set of elongate elements which are delivered at the same time to the practitioner. The latter may also prefer delivery in two stages, particularly when he chooses, as will be explained later, to put the elongate elements in place several months after fixing the zygomatic part of the implant. He may also choose to hold a large quantity of standard elongate elements in stock and to order from the manufacturer a specific zygomatic part for each patient. In all cases, the practitioner is ultimately provided with a kit or an assembly which comprises a zygomatic part and at least one elongate element intended to be fixed in the zygomatic part.

Other fixation means could be provided without departing from the scope of the invention.

The two elongate elements are here in the form of cylindrical rods.

However, the invention is not limited to this embodiment, and they could also be partially flattened or have an elliptical cross section, for example.

FIGS. 10 to 12 will now be used to describe the steps of the surgical method for placement of an implant according to the invention, made in several parts, such as the implant 4 illustrated in FIG. 8, with an operating guide as illustrated in FIG. 9.

FIG. 10 illustrates the lower part of the maxillary bone with the residual alveolar region 50 devoid of teeth.

The continuous line 51 represents the outline of the incision that the surgeon will make in the upper mucosa, here on the right-hand side.

This incision may be continued, at each of its ends, by a small incision 510, 511 for posterior vertical discharge.

Its topography is adapted to the extent of bone resorption (crestal or vestibular).

FIG. 11 illustrates, once the mucosa 52 has been incised, the subperiosteal detachment of the soft tissue parts covering the jugal face of the maxillary bone.

Retractors 53 are then put in place in order to expose the operating zone extending to the jugal face of the maxillary bone 54, to the lower orbital margin at the top (after exposure of the infra-orbital nerve 55 at its site of emergence), to the zygomaticomaxillary suture 56 outside, to the jugal face of the zygomatic bone 57, as far as the zygomatic process of the frontal bone 58 at the top and that of the temporal bone 59 at the rear.

The surgeon can then use a drilling guide 6, which is described with reference to FIG. 9.

This guide is custom-made for each patient prior to the operation. Its design will be described later, along with that of an implant also custom made prior to the operation.

It comprises a tray 60 which fits on the alveolar region 50 and continues over the palate.

This tray is connected by means of two stems 61, 62 to two plates 63, 64. The guide 6 is here designed for two implants (one implant on the right-hand side and one implant on the left-hand side) and it therefore comprises two stems and two tabs. Each tab corresponds to the position of the zygomatic part of the implant to be fitted and comprises openings corresponding to the openings for fixing the implant.

This guide is temporarily fixed to the palate by screws that are inserted into the openings 65, 66.

The surgeon can then drill holes into the zygomatic bone through the guide openings and, once drilling is complete, can remove the guide.

The zygomatic part of the implant is then put in place on the jugal face of the zygomatic bone and fixed in the bone by fixation screws or implant screws passing through the fixation openings of the implant and being screwed into the holes drilled in the bone.

The surgeon may provide for the placement of small bone grafts at appropriate points and in particular at the future contact zones between the elongate elements of the maxillary part and the lower margin of the maxillary bone.

The surgeon proceeds to close the access route, if the rest of the implant is intended to be fitted in place in a second stage.

Such placement is preferred for certain patients. It also makes it possible to verify the dimensions of the elongate elements of the maxillary part.

A few months later, the surgeon makes a repeat incision 51, as is illustrated in FIG. 10.

The mucosa is then detached in a similar but less extensive manner, and only as far as the zygomatic part of the implant, of which only the lower part is exposed.

The surgeon then places each elongate element of the maxillary part in position along the jugal face of the maxillary bone and inserts one of its ends into a corresponding fixation means of the zygomatic part, then locks the connection between them, for example by screwing.

Finally, the surgeon proceeds to close the access route.

Of course, the steps that have just been described are carried out in a similar manner for the placement of an implant on the patient's left-hand side.

Insofar as the free end of each elongate element is connected to an interface for connection with a dental prosthesis, the latter will be able to be put in place.

Of course, the implant can also be put in place in a single step, in particular when the implant is formed in one piece.

The various steps that have just been described confirm that the implant according to the invention eliminates all risks of opening the sinus, since the zygomatic part of the implant is fixed to the jugal face of the zygomatic bone, and its maxillary part extends facing the jugal face of the maxillary bone, without penetrating it.

Moreover, in view of the design of the implant according to the invention and the technique of putting it in place, it is possible to eliminate operating errors during its placement, such as accidental penetration into an adjacent region.

The implants according to the invention may be standard implants provided in several different dimensions, so that the surgeon can choose the one that is most appropriate for his patient.

Given the bone loss suffered by the patient, the height of the maxillary bone is reduced and is generally between 1.5 and 2 cm.

This is why the length of each elongate element will generally be between 10 and 20 mm.

In the case of standard implants, each elongate element may be in the form of a cylindrical rod with a diameter of less than 4.5 mm and with a very variable length, less than 8 mm and up to more than 25 mm. These standard implants will be able to be provided in several lengths, for example equal to 10 mm, 12 mm, 14 mm, 16 mm, 18 mm or 20 mm.

Moreover, it will also be possible for the zygomatic part to be made available in several different sizes and shapes.

By way of example, the implants will be available in two or three sizes and for each side, right and left.

The implants according to the invention can also be custom made prior to an operation, according to a computer protocol based on the CT data of each patient and on those of the library of characteristics of the zygomatic and maxillary parts.

For this purpose, imaging of the patient's skull, in particular of the lower region of the skull, is carried out, for example by means of a CT scan or cone beam computed tomography (CBCT).

The images obtained from the CT scan or cone beam computed tomography are then loaded onto a computer. Image-processing software makes it possible to create a virtual model of the skull, which will be able to be manipulated by a user and will serve in particular as a support for the design of customized equipment.

This image processing and this manipulation can be carried out using standard software, such as the Mimics software marketed by the company Materialise. Such software enables the user, particularly a surgeon, to analyze the characteristics of the patient and to design virtually both a custom-made implant and a custom-made guide.

On the basis of the virtual model of the skull, the surgeon first designs a drilling guide, such as the one illustrated in FIG. 9.

This guide is specific to each patient, and it is therefore produced according to the data of computer files established from the scan (or from a cone beam) of the patient and from a prosthetic assembly of the teeth appearing on the final prosthesis, produced from the patient-specific occlusal plane.

To do this, on the virtual model of the skull, the surgeon determines the locations of the holes for fixing the zygomatic part of the implant in the zygomatic bone.

He then determines the dimension of the constituent elements of the guide and also their shape.

A digital file corresponding to the virtual model of the surgical guide can then be stored in a memory of the computer.

In a variant, after the design of a prosthesis, a CT image thereof is produced which is superimposed with those of the scan of the bone structures in order to make a surgical guide allowing the implant to be put in place.

The user or the surgeon then designs a virtual implant model, still using the virtual model of the skull.

Thus, the zygomatic part of the implant will have a generally curved shape which will be adapted to that of the zygomatic bone of the patient and, in particular, the surface of the (internal and convex) face of this zygomatic part, intended to come into contact with the jugal face of the bone, will be chosen to fit it.

The orientation of the elongate elements will also be adapted to the skull of the patient, and the fixation means provided on the zygomatic part of the implant will be designed accordingly.

Similarly, the length and shape of each elongate element will be chosen to adapt to the dimensions and shape of the maxillary bone. These elongate elements can thus be slightly curved. However, it should be noted that, given the short length of the elongate elements, their curvature is relatively small.

A digital file corresponding to the virtual model of the implant will then be able to be stored in a memory of the computer.

These two digital files can then be transferred from the computer to a 3D printer or conventional CAD/CAM manufacturing machine to manufacture the surgical guide and the implant.

It will be understood that a design of the implant in several independent parts makes it possible to combine all the possibilities that have been described: to use two standard parts of the implant or, on the contrary, to produce the two parts individually, to produce the zygomatic part of the implant in an individualized or custom-made manner and moreover to use standard elongate elements or, finally, to use a standard zygomatic part and produce the elongate elements in a custom-made manner.

Finally, an implant made of several standard components makes it easier to adapt to the morphology of a patient, starting from a limited number of different components.

Such an implant also has the advantage of simplifying interventions when the implant has to be dismantled, in particular when an inflammatory phenomenon of the peri-implantitis type is observed. In this case, as soon as the diagnosis is made, one or more elongate elements are removed by detaching them from the zygomatic part. Once this peri-implantitis has healed, elongate elements are put back in place, without the need to remove the zygomatic part.

Regardless of the type of implant, whether in several parts or in one piece, removal of the zygomatic part, if this proves necessary, does not cause bone damage, because the screws are removed from the outside of the bone. Thus, even if the screws are osseointegrated, they are easily accessible, and it is in particular not necessary to make a cut in the bone in order to reach them, as happens with conventional zygomatic implants.

The invention is not limited to the embodiments more particularly described. On the contrary, it encompasses all variants thereof and in particular those in which the shape of the zygomatic part or of the elongate elements is different from that described and those in which, for an implant made in several parts, the fixing between these parts is achieved by means different from those described and/or illustrated.

1. A zygomatic implant (1, 3, 4) for supporting a dental prosthesis and for being fixed only to the jugal face of the zygomatic bone (21) of a patient, this implant comprising:
A zygomatic fixation part (10, 30, 40) arranged to be fixed to the jugal face (210) of the zygomatic bone of a patient, forming a plate, in which there is defined at least one fixation opening (100, 101, 102; 300, 301, 302; 400, 401, 402) which extends through the plate and which is configured to receive a fixation element (103, 104, 105; 303, 304, 305) so as to fix the plate to the jugal face of the zygomatic bone of a patient;
A maxillary part (11, 31, 41) comprising at least one elongate element (11; 310, 311; 410, 411) arranged to extend facing the jugal face of the maxillary bone of the patient, and one end of which is connected to the zygomatic part, and the other end of which is free and is intended to be connected to a connection interface with a dental prosthesis.

2. The implant as claimed in claim 1, wherein the zygomatic part (10; 30) is formed integrally with the maxillary part (11; 31).

3. The implant as claimed in claim 1, made in at least two independent parts, wherein the zygomatic part (40) defines at least one fixation means (406, 407) for an elongate element (410, 411).

4. The implant as claimed in claim 1, wherein said plate comprises a single fixation opening.

5. The implant as claimed in claim 4, comprising, on its convex internal face intended to be in contact with the jugal face of the zygomatic bone, at least one relief projecting with respect to said internal face.

6. The implant as claimed in claim 1, wherein said plate (11, 31, 41) comprises at least two fixation openings.

7. The implant as claimed in claim 1, wherein the maxillary part (31, 41) comprises at least two elongate elements (310, 311; 410, 411), said elongate elements forming an acute angle between them.

8. The implant as claimed in claim 1, wherein said zygomatic part is pre-operatively pre-formed in order to match the external shape of the zygomatic bone of the patient.

9. The implant as claimed in claim 1, wherein said at least one elongate element is pre-operatively pre-formed in order to match the shape and dimensions of the jugal face of the maxillary bone of the patient.

10. A kit for producing a zygomatic implant (4) intended to receive a dental prosthesis and to be fixed only to the jugal face of the zygomatic bone (21) of a patient, comprising:
A zygomatic fixation part (40) arranged to be fixed to the jugal face of the zygomatic bone of a patient, forming a plate, in which there is defined at least one fixation opening (400, 401, 402) which extends through the plate and which is configured to receive a fixation element so as to fix the plate to the jugal face of the zygomatic bone of a patient, the zygomatic part defining at least one fixation means (406, 407) for an elongate element, in which said elongate element can be removably fixed, and
At least one elongate element (410, 411) arranged to extend facing the jugal face of the maxillary bone of the patient, and one end of which is intended to be fixed in a fixation means of the zygomatic part, and the other end of which is free and is intended to be connected to an interface for connection with a dental prosthesis.

11. The kit as claimed in claim 10, wherein said zygomatic part is pre-operatively pre-formed in order to match the external shape of the zygomatic bone of the patient.

12. The kit as claimed in claim 10, wherein said zygomatic part is standard.

13. The kit as claimed in claim 10, wherein said at least one elongate element is pre-operatively pre-formed in order to match the shape and dimensions of the jugal face of the maxillary bone of the patient.

14. The kit as claimed in claim 10, wherein said at least one elongate element is standard.

15. A surgical method for placement of an implant as claimed in claim 1, comprising the following steps:
Incision of the upper vestibular mucosa, at the alveolar region devoid of residual teeth;
Subperiosteal detachment exposing the jugal face of the maxillary bones and the jugal face of the zygomatic bone;
Drilling into the zygomatic bone, from its jugal face, holes for fixing the fixation elements of the implant;
Placement of the zygomatic part of the implant on the jugal face of the zygomatic bone and its fixation in the latter by means of fixation screws;
Closure of the access route.
